(19) United States
(12) Patent Application Publication
(10) Pub. No.: US 2017/0151909 A1
(43) Pub. Date: Jun. 1, 2017

(54) IMAGE PROCESSING BASED DYNAMICALLY ADJUSTING SURVEILLANCE SYSTEM

(71) Applicant: Razmik KARABED, San Jose, CA (US)

(72) Inventor: Razmik KARABED, San Jose, CA (US)

(21) Appl. No.: 14/985,645

(22) Filed: Dec. 31, 2015

Related U.S. Application Data
(60) Provisional application No. 62/261,247, filed on Nov. 30, 2015.

(51) Int. Cl. B60R 1/00; H04N 5/232; B60K 35/00; G06K 9/00

(52) U.S. Cl. CPC B60R 1/00; G06K 9/00805; H04N 5/23293; B60K 35/00; B60R 2300/804

(57) ABSTRACT

An image processing based dynamically adjusting surveillance system includes a camera configured for capturing a view that contains a key region encompassing a desired key view. The system further includes a control unit receiving images from the camera and a monitor that displays images it receives from the control unit. The system may include a first and a second predetermined region of camera view. In one application, the first predetermined region is chosen to include the blind spot of the side mirror. The second predetermined region is chosen to correspond generally to a region observed in a conventional side mirror. When there is no object of interest in the blind spot of a driver, the controller displays the view of the camera that is in the second predetermined region. When there is an object of interest in the blind spot of a driver, the controller displays the first predetermined region.

### CROSS-REFERENCE TO RELATED APPLICATIONS

This application claims the benefit of priority to U.S. provisional patent application No. 62/261,247, filed Nov. 30, 2015, the contents of which are herein incorporated by reference.

### BACKGROUND OF THE INVENTION

1. Field of the Invention

One or more embodiments of the invention relates generally to surveillance devices and methods, and more particularly to dynamically adjusting surveillance devices that can, for example, assist a driver when changing lanes.

2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A large number of car crashes is due to inadequate surveillance during lane changes. Thus, improving surveillance during lane changes will reduce car crashes significantly. During lane changes, views provided by traditional car side mirrors place a driver of a car in a vulnerable position, as explained below.

Referring to FIG. 1, three lanes 1, 2 and 3 are shown. Also, five automobiles 10, 20, 30, 40 and 50 are depicted. The automobile 20 is in lane 2. It has a left side mirror 21 and a right side mirror 22. The left side mirror 21 provides a viewing angle characterized by points [XL OL YL]. The right side mirror 22 provides a viewing angle characterized by points [XR OR YR].

The automobile 40 falls inside the viewing angle [XL OL YL], but the automobile 10 falls outside the viewing angle [XL OL YL] of the left side mirror 21. The automobile 10 is said to be in the blind spot of the left-side mirror 21.

Similarly, the automobile 50 falls inside the viewing angle [XR OR YR], but the automobile 30 falls outside the viewing angle [XR OR YR] of the right side mirror 22. The automobile 30 is said to be in the blind spot of the right-side mirror 22.

Since the automobile 10 is not visible in the left-side mirror 21, when the automobile 20 is making a left-side lane change into the lane 1, if it is not careful, it might collide with the automobile 10. A driver of the automobile 20 needs to look over his left shoulder to spot the automobile 10.

Similarly, since the automobile 30 is not visible in the right-side mirror 22, while the automobile 20 makes a right-side lane change into the lane 3, if it is not careful, it might collide with the automobile 30. A driver of the automobile 20 needs to look over his right shoulder to spot the automobile 30.

Steps taken to improve surveillance during lane changes involve the following: (1) employment of sensors to detect the automobiles 10 and 30, (2) rotation of the side mirrors to generate a driver of the automobile 20 with the views of the automobiles 10 and 30 as described in U.S. Pat. Nos. 5,132,851, 5,306,953, 5,980,048 and 6,390,631, and International Application No. PCT/US2015/042498, (3) use of cameras and monitors to generate and display the automobiles 10 and 30 to a driver of the automobile 20 as described in U.S. Provisional Patent Application Ser. No. 62/132,384 filed on Mar. 12, 2015 and entitled “Dynamically Adjusting Surveillance Devices”), and (4) generation of signals warning a driver about the automobiles 10 and 30.

In general, mirrors are usually rotated with stepper motors. Smooth motion is achieved with using small steps and mechanical dampening means. These steps increase the overall cost and design complexity of a system. Even though the use of sensors is very common in the automobile industry, nevertheless, many times sensors contribute to false alarms and missed detections.

Accordingly, a need exists for motor-less and sensor-less dynamically adjusting surveillance systems.

### SUMMARY OF THE INVENTION

In accordance with the present invention, structures and associated methods are disclosed which address these needs and overcome the deficiencies of the prior art.

U.S. Provisional Patent Application Ser. No. 62/132384 filed on Mar. 12, 2015 and entitled “Dynamically Adjusting Surveillance Devices”, the contents of which are herein incorporated by reference, makes the following modification to dynamically adjustable surveillance systems: devices that rotate the surveillance devices, such as cameras or mirrors are eliminated. These devices usually are motors.

The current application goes further in improving dynamically adjustable surveillance system by eliminating all sensors, except cameras.

Objects in a driver's blind spot are detected only by image processing of an image(s) of a camera.

The advantages obtained over the conventional designs include the following: 1) Improved reliability: Sensors contribute to false alarms and missed detections. False alarms relate to situations where there is no automobile in a driver's blind spot but sensors falsely are detecting one, and missed detections relate to situations where there is an automobile in a driver's blind spot but sensor are not detecting it. 2) Less cost: Sensors contribute to the cost of the dynamically adjustable surveillance system. Therefore, their elimination lowers the overall cost.

In an aspect of the present invention, an image processing based dynamically adjusting surveillance system of a moving vehicle is disclosed. The system includes a camera configured for capturing a view that contains a key region encompassing a desired key view.

The system further includes a control unit receiving images from the camera at a rate of “f” images per second.

The system further includes a monitor that displays images it receives from the control unit.

The system may include a first and a second predetermined region of camera view.

In one application, the first predetermined region is chosen to include the blind spot of the side mirror. The second predetermined region is chosen to correspond generally to a region observed in a conventional side mirror. When there is no object of interest in the blind spot of a driver, the controller displays, on the monitor, the view of the camera that is in the second predetermined region. But when there is an object of interest in the blind spot of a driver, the controller displays, on the monitor, the view of the camera that is in the first predetermined region.

As used herein, the term “blind spot event” refers to a situation when an object of interest is not in the view of a conventional side mirror.

In a first exemplary embodiment, in the absence of a blind spot event, equivalently when there is no object of interest in the blind spot of a driver, the key region is defined as the second predetermined region. But, in the presence of a blind spot event, when there is an object of interest in the blind spot of a driver, then the key region is defined as the first predetermined region. In this embodiment, the later key region does not contain the former key region.

In an exemplary embodiment, the controller first detects key pictorial feature(s) of objects of interest in the images of the camera, next it detects “blind spot events” based on the detected pictorial features.

In an exemplary embodiment, the pictorial features of objects of interest include one or more from the following list: 1) automobile tires, 2) automobile body, 3) automobile front lights, 4) automobile brake lights, 5) automobile night lights, and the like.

In another exemplary embodiment, again in the absence of a blind spot event, the key region is defined by the second predetermined region. But, in the presence of a blind spot event, the key region typically is a portion of the camera image that not only contained the second predetermined region but also at least one detected feature of at least one object of interest. Thus, in this embodiment, the key region always contains the second predetermined region.

In one exemplary embodiment, the controller first detects key pictorial feature(s) of objects of interest in the images of the camera, next it detects “blind spot events” based on the detected features.

In an exemplary embodiment, the pictorial features include one or more from the following list: 1) automobile tires, 2) automobile body, 3) automobile front lights, 4) automobile break lights, 5) automobile night lights, and the like.

Embodiments of the present invention provide an image processing based dynamically adjusting surveillance system which comprises at least one camera configured to capture a view containing a key region that encompasses a desired view; a control unit receiving a camera image from the camera, the control unit using image processing based detection configured to detect desired objects in a region of the image of the camera; and a monitor that displays images it receives from the control unit

Embodiments of the present invention further provide an image processing based dynamically adjusting surveillance system which comprises at least one camera configured to capture a view containing a key region that encompasses a desired view, wherein the view includes a first predetermined region and a second predetermined region; a control unit receiving the view from the camera, the control unit using image processing based detection configured to detect desired objects in a region of the view of the camera; and a monitor that displays images it receives from the control unit, wherein the key region is the first predetermined region when the controller detects a desired object inside the first predetermined region; and the key region is the second predetermined region when the controller does not detect any desired object inside the first predetermined region.

Embodiments of the present invention also provide a method for detecting when a vehicle lane change may be safely completed, the method comprises capturing a view containing a key region that encompasses a desired view with at least one camera; receiving a camera image from the camera to a control unit; detecting a desired object in a region of the camera image with image processing based detection; and display at least a portion of the camera image on a monitor.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates conventional left and right side mirror views of a vehicle;

FIG. 2 illustrates an image processing based dynamically adjusting surveillance system in accordance with an exemplary embodiment of the present invention;

FIG. 3 illustrates a view of an image module of a camera when the automobile is in a situation similar to one depicted in FIG. 1;

FIG. 4 illustrates a schematic representation of a controller of the image processing based dynamically adjusting surveillance system in accordance with an exemplary embodiment of the present invention;

FIG. 5 illustrates a more detailed schematic representation of a controller of the image processing based dynamically adjusting surveillance system in accordance with an exemplary embodiment of the present invention;

FIG. 6 illustrates a feature detector matrix used in the controller of FIG. 5, in accordance with an exemplary embodiment of the present invention;

FIG. 7 is a flow chart describing the finite state machine characterization of the blind spot event detector of FIG. 5, in accordance with an exemplary embodiment of the present invention;

FIG. 8 illustrates a schematic representation of a controller of the image processing based dynamically adjusting surveillance system in accordance with an exemplary embodiment of the present invention, where image frames are entering the controller;

FIG. 9 illustrates a view of an image module of a camera when an automobile is in a situation similar to one depicted in FIG. 1, according to another exemplary embodiment of the present invention;

FIG. 10 illustrates a view of an image module of a camera when an automobile is in a situation similar to one depicted in FIG. 1, according to another exemplary embodiment of the present invention;

FIG. 11 illustrates a schematic representation of a controller of the image processing based dynamically adjusting surveillance system in accordance with an exemplary embodiment of the present invention, where image frames are entering the controller; and

FIG. 12 illustrates a view of an image module of a camera when an automobile is in a situation similar to one depicted in FIG. 1, according to another exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

### The First Embodiment

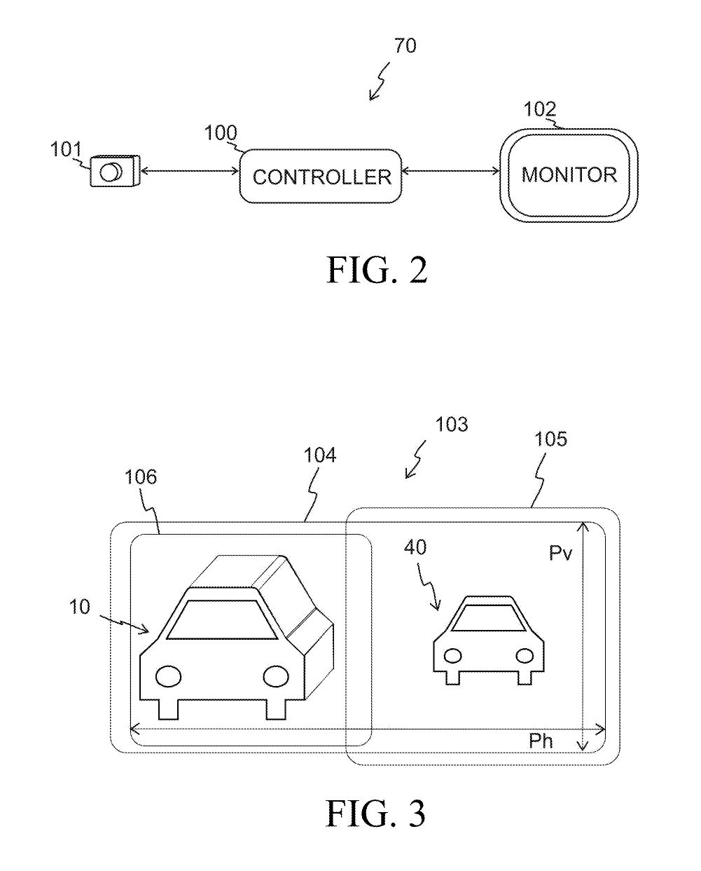

A first embodiment of the present invention relates to the left-side mirror 21 and it is explained using FIGS. 2-8. More specifically, referring to FIG. 2, at high-level, the first embodiment of an image processing based dynamically adjusting surveillance system 70 comprises a controller 100, a video camera 101 (also referred to as camera 101), and a monitor 102. Both the camera 101 and the monitor 102 are connected to the controller 100.

The camera 101 has a lens which might have a medium to wide angle, and it generates f images per second, sending the images to the controller 100. In an exemplary embodiment f may be about 30 images per second. Referring to FIG. 3, the camera 101 has an image module 103 that comprises pixels configured in a rectangular area 104. There are Ph pixels in each row and Pv pixels in each column.

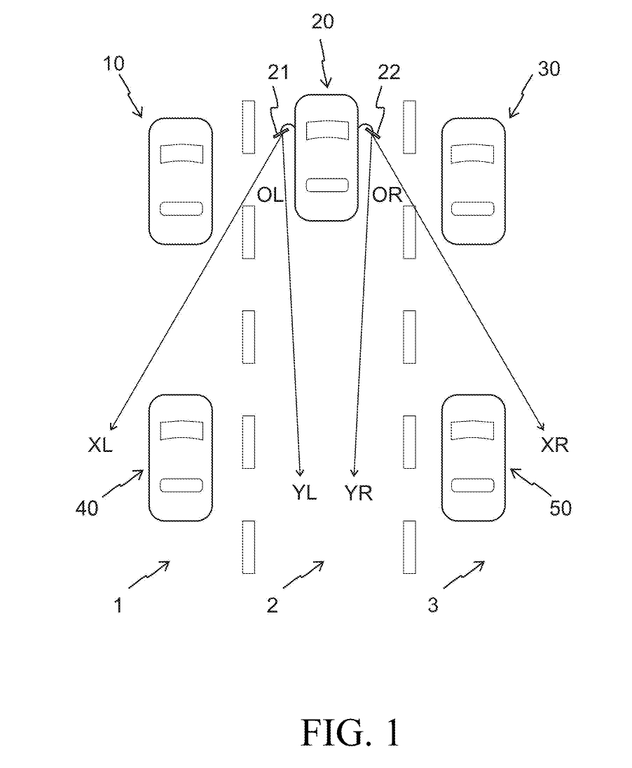

When the image processing based dynamically adjusting surveillance system 70 is used instead of the left side mirror 21, then FIG. 3 shows a view of the image module 103 of the camera 101 when the automobile 20 is in a situation similar to one depicted in FIG. 1. While the left-side mirror 21 shows only the automobile 40, it is noted that both automobiles 10 and 40 are in the view of the image module 103 in FIG. 3. In FIG. 3, a rectangle 105 is used to show the pixels of the image module 103 that generally correspond to a view of the left-side mirror 21. The region defined by the rectangle 105 is the second predetermined region in this embodiment. A rectangle 106 is used to show the pixels of the image module 103 that generally correspond to a view of the blind spot of the left-side mirror 21. The region defined by the rectangle 106 is the first predetermined region in this embodiment.

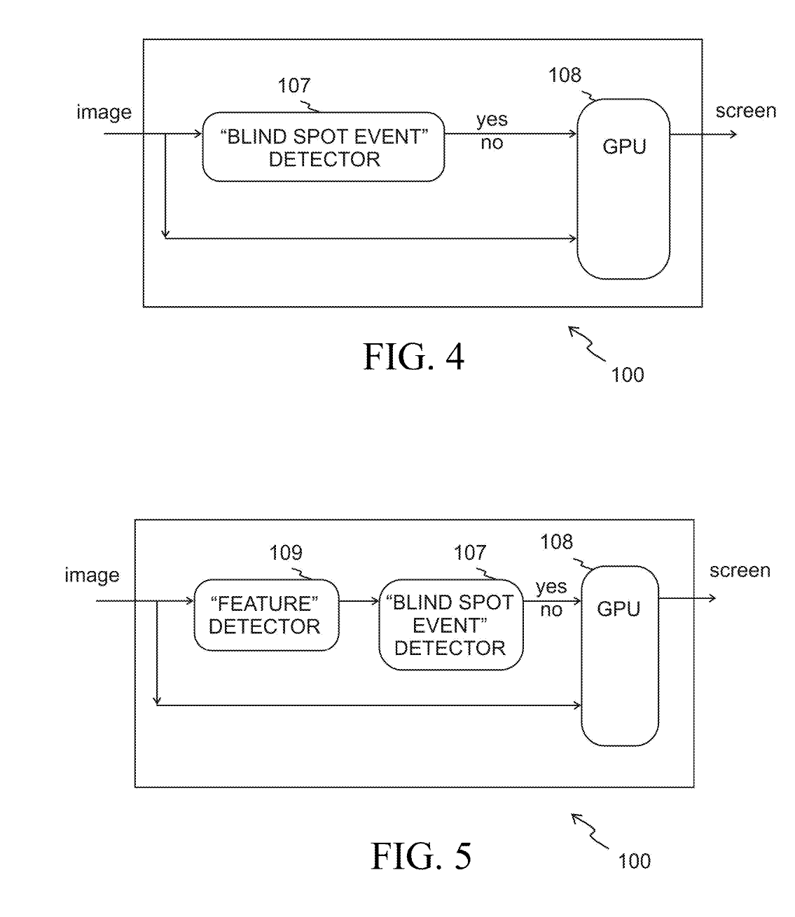

FIG. 4 depicts the controller 100. At a high-level, the controller 100 can be described by a blind spot event detector 107 followed by a graphic processing unit, GPU, 108.

After receiving an image from the camera 101, the blind spot event detector 107 first checks if there is a blind spot event present or not. Next, the blind spot event detector 107 communicates its finding to the GPU 108 in the form of a ‘yes’ or a ‘no’. A ‘yes’ could be communicated, for example, by a sending a digital ‘1’ to the GPU 108, and a ‘no’ can be communicated by sending a digital ‘0’ to the GPU 108. The GPU 108 communicates with the monitor 102 by sending an output called ‘screen’.

If the GPU 108 receives a ‘0’, indicating no blind spot events, then its output ‘screen’ is based on the pixels in the rectangle 105, the second predetermined region, of FIG. 3. Therefore, the view of the monitor 102 would correspond to a view of the left-side mirror 21.

For example, if the automobile 10 is not present but the automobile 40 is present, then there is no blind spot event and the output of the blind spot event detector 107 would be ‘0’ and the output of the GPU 108, ‘screen’, would correspond to a view containing the automobile 40 based on the pixels in the rectangle 105.

But if the GPU 108 receives a ‘1’, indicating a blind spot event, then its output, ‘screen’, is based on the pixels in the rectangle 106, the first predetermined region, of FIG. 3.

Therefore, the view of the monitor 102 would correspond to a view of the blind spot of left-side mirror 21.

For example, if the automobile 10 is present but the automobile 40 is not present, then there is a blind spot event and the output of the blind spot event detector 107 would be a ‘1’ and the output of the GPU 108, ‘screen’, would correspond to a view containing the automobile 10 based on pixels in the rectangle 106.

It is noted that if both automobiles 10 and 40 are present, then the view of the monitor 102 would be the same as in the case when only the automobile 10 is present. This bias toward the automobile 10 is intentional since the automobile 10 threatens the safety of the automobile 20 more than the automobile 40 does in general. For example, if the driver of the automobile 20 changes into his/her left lane, then the automobile 20 would crash into the automobile 10.

Thus, image processing based dynamically adjusting surveillance system 70 provides a view of the blind spot of the left-side mirror 21 when there is an automobile in the blind spot.

In general, it is computationally burdensome to detect blind spot events based on general properties of an image. Therefore, certain pictorial features of an image that are easy to compute and are good indicators of blind spot events are first detected, and then blind spot events based on the detected features are detected.

Referring to FIG. 5, the controller 100 is described more specifically. The task of the “blind spot event detector” 107 is split into two parts: 1) a feature detector 109, and 2) the blind spot event detector 107 based on the detected feature.

Generally, the task of the feature detector 109 is to detect pictorial features and their general location in an image that would indicate the presence of an object of interest, an automobile, for instance. The task of the blind spot event detector 107 generally is to receive, from the feature detector 109, detected features and their general location in the image and then to decide if those features fall in the blind spot area of a side mirror or not.

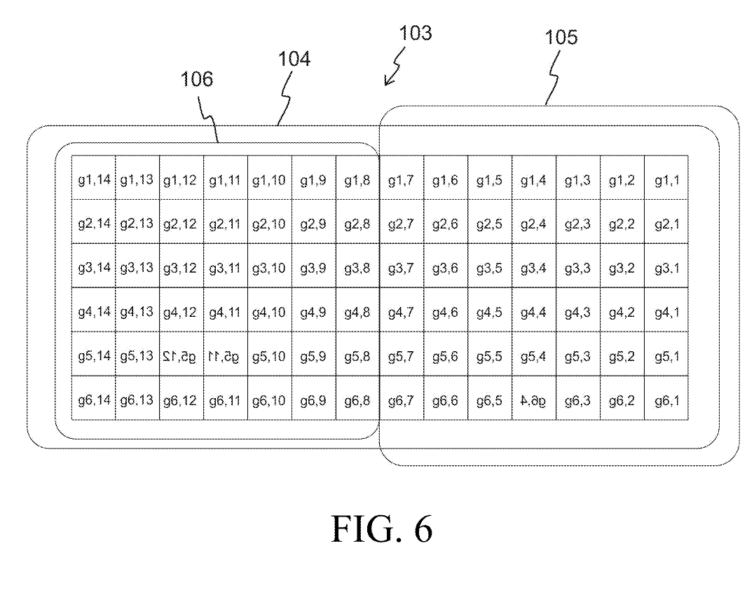

Referring to FIG. 6, the feature detector 109 positions an (r×c) grid on the rectangle 104 of the image module 103. For FIGS. 6, r=6, and c=14. The square in the i-th column from the right side, and in the j-th row from the top is labeled by gi,j.

The feature detector 109 is configured to detect one or more of the pictorial features, such as the pictorial features in the following list: 1) automobile tires, 2) automobile body, 3) automobile front lights, 4) automobile break lights, and 5) automobile night lights.

Here, an RBG color format is used to describe the above features. Each color is characterized by a triplet (r,b,g), where r, b, and g are integers, and 0≦r, b, and g≦255.

Therefore, the color of each pixel in the image module 103 is represented by a triplet (r, b, g).

There are many norms that one might use to measure closeness of two colors. For example, a maximum norm may be used, where the distance between (r1 b1 g1) and (r2 b2 g2) is max(|r1−r2|, |b1−b2|, |g1−g2|), where |x| denotes the absolute value of x.

For each feature, k, in the above list, there corresponds:

1) a set, ck={ck,1,ck,2, . . . ,ck,qk}, of predetermined color(s), where qk is an integer, and ck,t, 1≦t≦qk, are RBG triplets,

2) a set, ok={ok,1,ok,2, . . . ,ok,qk}, of color offset(s) or tolerances,

3) a density threshold, dk, and

4) an (r×c) binary matrix, Mk.

A pixel can be described as having a color ck within tolerance (or offset) of ok if for some t, 1≦t≦qk, |color of the pixel−ck,t|≦ok,t. Now if feature k is a configured feature, then for a given image,

Mk(i,j)=1 if the number of pixels in the square gi,j that have a color within ok of ck is greater than dk*total number of pixels in gi,j, and

Mk(i,j)=0 otherwise.

It is noted that for each binary matrix, Mk, a ‘1’ in a location (i,j) would indicate the presence of a feature, k, in the square gi,j of the image module 103. A ‘0’ in a location (i,j) would indicate the absence of a feature, k, in the square gi,j of the image module 103.

For each configured feature, k, the feature detector 109 generates its corresponding binary matrix, Mk, and then passes it to the blind spot event detector 107.

For feature 1, “1) automobile tires”, one might use the following:

c1={c11=(0 0 0)}, ((0 0 0) indicates black in RBG format),

o1={o11=3.}, and

d1=0.1.

Therefore, the feature detector assigns a ‘1’ to M1(i,j) if more than 10% (d1=0.1) of the pixels in gi,j are ‘almost black’ (o11=3). Thus, more specifically, a color (r1,b1,g1) is ‘almost black’ in this context if |(r1−0)|<=o11=3, |(b1−0)|<=o11=3, and |(g1−0)|<=o11=3.

For feature 2, “automobile body”, one might use the following:

1) c2={c2,1,c2,2, . . . ,c2,q2}, where c2,i's are predetermined colors,

2) o2={o2,1=5.,o2,2=6., . . . ,o2,q2=7.}, where o2,i's are color offsets, and

3) dk=0.3.

Now, the color set c2 can be a collection of colors used by different automobile manufacturers. The tolerances or allowed offsets, o2, allow the detection of the same automobile body color in the shade or in the sun. For the detection in darker shades and/or brighter sun, larger values of the offsets are required.

The features given in the list above are both feasible to detect and indicative of the presence of objects of interest, like another automobile. They also apply for indicating most object of interest related to blind spots: motorcycles, trucks, and the like.

Referring to FIG. 6, some of the squares, gi,j's, might not be relevant to the detection of the blind spot events. For instance, g6,1 might be ignored since in many satiations it contains a view of the side of the automobile 20 itself. In addition, g6,1 might be ignored since it is far from the blind spot, and objects of interest approaching the blind spot might be sufficiently detected with the help of the other squares. Ignoring squares that are not relevant to the detection of the blind spot events reduces the hardware and computational burden of the image processing based dynamically adjusting surveillance system 70.

The image processing based dynamically adjusting surveillance system 70 might use floating matrices instead of using binary matrices for the features. Floating matrices have coordinates that are floating numbers. In this case, the (i,j) coordinate of a floating matrix, Mk, would be the percentage of pixels in the square gi,j that have a color within ok of ck. The blind spot event detector 107 might use these percentages to detect the presence of an object of interest in the blind spot. Of course, using floating matrices instead of binary matrices would increase the hardware and computational complexity. The feature detector 109 might modify its color offset, ok,j, of a color, ck,j, by defining a triplet, (ok,j(r), ok,j(b), ok,j(g)), where ok,j(r) is the allowable offset for the red coordinate of the color ck,j, in the RBG format, and ok,j(b) is the allowable offset for the blue coordinate of the color ck,j, in the RGB format, and ok,j(g) is the allowable offset for the green coordinate of the color ck,j, in the RGB format. Then a color (r, b, g) is determined to be within offset ok,j of a color ck,j if |r1−r|<ok,j(r), |b1−b|<ok,j(b), and |g1−g|<ok,j(g), where the RBG representation of the color ck,j is (r1 b1 g1). Using triplet offsets would increase the hardware and computational complexity.

Below, an alternate method for detecting a portion of the body of an automobile having an RBG, color (r0 b0 g0), for some integers 0≦r0, b0, and g0≦255 is provided. In general, real time detection of an unspecified moving object by image processing is not feasible at low costs because of the number of computations it requires. However, searching for pixels that have close shades or close tints of a same color are orders of magnitude easier. Thus, the below algorithm is proposed:

a) Referring to the grid squares, gi,j's, in FIG. 6, first a corner pixel in each square is selected and its color recorded;

b) For each square, gi,j, if the number of pixels that have a color near a close shade or a close tint of the square's recorded color is greater than a threshold, then that square is marked as containing a part of an automobile body;

c) All marked squares are communicated to the blind spot event detector 107; and

d) If the number of marked squares in the rectangle 106 is greater than a predetermined number, then the blind spot event detector 107 outputs a yes; otherwise it outputs a no.

This method might be used for detecting a monochromatic part of any object.

Next, to explain the blind spot event detector 107 in its simplest form, referring to FIG. 5 and given an image, and the feature matrices from the feature detector 109, the blind spot event detector 107 checks if any one of the received matrices has a ‘1’ in the columns defined by the rectangle 106 of FIG. 6. A ‘1’ in these columns indicates the presence of a configured feature in the image module 103 in the rectangle 106, the first predetermined region. Therefore, in this case, the blind spot event detector 107 outputs a ‘yes’, a digital ‘1’. If all coordinates of the matrices corresponding to the columns in the rectangle 106 are zeros, then this would indicate the absence of all configured features in the image module 103 in the rectangle 106. Therefore, in this case, the blind spot event detector 107 outputs a ‘no, a digital ‘0’.

Nevertheless, in order to preclude false detection of a few pathological situations, a more complex algorithm may be used for the blind spot event detector 107. To this end, the following finite state machine description may be used for the blind spot event detector 107.
The blind spot event detector 107 has an internal three dimensional state s=(s1, s2, s3). The state, s, is initialized in the beginning.
The blind spot event detector 107 receives the configured features matrices, M1-M5. If a feature, k, 1≦k≦5 is not configured then its corresponding matrix has all zeros.
The blind spot event detector 107 uses the steps below to compute its new state. In the first embodiment, the parameters q1 and q2 that are used below are, q1=7, and q2=2. The current state, s, is assumed to be (Old1 Old2 Old3).

The new s1, New1, computation is as follows:

New1=0, if all M1-M5 are zeros; and

New1=i, 1≦i≦r, (recall matrices M1-M5 have r rows and c columns) if the i-th row is the lowest non-zero row among M1-M5.

The new s2, New2, computation is as follows:

New2=0, if all M1-M5 are zeros; and

New2 j, 1≦j≦c, if the j-th column is the leftmost non-zero column among M1-M5. (It is assumed that (1,1) coordinate of each M is at its top row, and rightmost column; as for the squares, gi,j's in FIG. 6.)

The new s3, New3, computation is as follows:

1) If (New2≦q1) AND (New1≠Old1), then New3=0. With respect to the rectangle 105 of FIG. 6, these conditions imply a) a detected feature, and b) a motion with respect to the previous frame (New1≠Old1). With respect to the rectangle 106, these conditions imply the absence of a detected feature (New2≦q1).

2) If (New2≦q1) AND (New1=Old1), then New3=Old3. With respect to the rectangle 105, these conditions imply a) a detected feature, and b) and an uncertainty about motion with respect to the previous frame (New2=Old1). With respect to the rectangle 106, these conditions imply the absence of a detected feature (New2≦q1).

3) If (New2>q1) AND (New1<Old1), then New3=0. With respect to the rectangle 106, these conditions imply a) a detected feature (New2>q1), and b) and an upward motion with respect to the previous frame (New1<Old1).

4) If (New2>q1) AND (New1=Old1), then New3=Old3. With respect to the rectangle 106, these conditions imply a) a detected feature (New2>q1), and b) and an uncertainty about motion with respect to the previous frame (New2=Old1).

5) If (New2>q1) AND (New1>Old1) AND (Old1>0) AND New2−Old2≦q2, then New3=1. With respect to the rectangle 106, these conditions imply a) a detected feature (New2>q1), b) and a downward motion with respect to the previous frame (New1>Old1), c) the presence of the detected feature in the previous frame (Old1>0) and d) leftward motion of no more than 2 squares from the previous frame.

6) If (New2>q1) AND (New1>Old1) AND (Old1>0) AND (New2−Old2>q2), then New3=0. With respect to the rectangle 106, these conditions imply a) a detected feature (New2>q1), b) and a downward motion with respect to the previous frame (New1>Old1), c) the presence of the detected feature in the previous frame (Old1>0) and d) leftward motion of more than 2 squares from the previous frame. In the first embodiment, in condition 6), motion of 3 or more squares from a frame to the next frame indicates a high likelihood of more than one object of interest facing in the opposite direction.

7) If (New2>q1) AND (New1>Old1) AND (Old1=0), then New3=0. With respect to the rectangle 106, these conditions imply a) a detected feature (New2>q1), b) and a downward motion with respect to the previous frame (New1>Old1), c) the absence of the detected feature in the previous frame (Old1=0). Therefore, these conditions imply a leftward motion of more than 3 squares, New2−Old2=New2−0>q1=7.

In the first embodiment, in condition 7), motion of 3 or more squares from a frame to the next frame indicates a high likelihood of more than one object of interest facing in the opposite direction.
The blind spot event detector 107 outputs New3 (‘0’ or ‘1’) and updates its state to s=(New1 New2 New3).

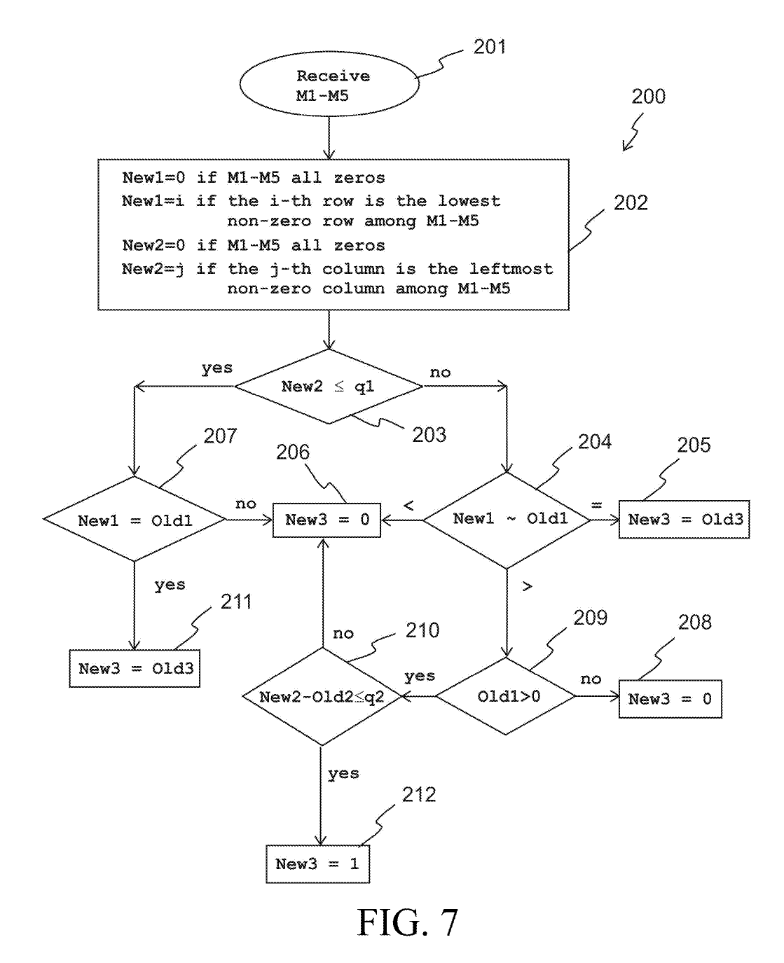

A flow chart 200 of FIG. 7 describes the finite state machine characterization of the blind spot event detector 107. The flow chart has 12 boxes: 201-212. The new s1 and s2 are generated in the box 202.

The flow defined by the boxes: 203, 207, and 206 describe the condition 1) above.

The flow defined by the boxes: 203, 207, and 211 describe the condition 2) above.

The flow defined by the boxes: 203, 204, and 206 describe the condition 3) above.

The flow defined by the boxes: 203, 204, and 205 describe the condition 4) above.

The flow defined by the boxes: 203, 204, 209, 210, and 212 describe the condition 5) above.

The flow defined by the boxes: 203, 204, 209, 210, and 206 describe the condition 6) above.

The flow defined by the boxes: 203, 204, 209, and 208 describe the condition 7) above.

In the current design of the controller 100, while the output of the blind spot event detector 107 is a ‘no’, the GPU 108 displays a view in the image module 103 that is in the rectangle 105, the second predetermined region. Once an object is detected in the blind spot area, or equivalently, if the blind spot event detector 107 outputs a ‘yes’, then the GPU 108 displays the view in the image module 103 that is inside the rectangle 106, the first predetermined region.

The operation of the image processing based dynamically adjusting surveillance system 70 according the first embodiment might generally be unaffected if only the gi,j's where j>5 are used. This restriction would simply the design of the image processing based dynamically adjusting surveillance system 70.

It is also desirable to prevent false detections of blind spot events that appear for only a few frames, d; for example, d=2. To this end, the controller 100 is adapted using the following four modifications.

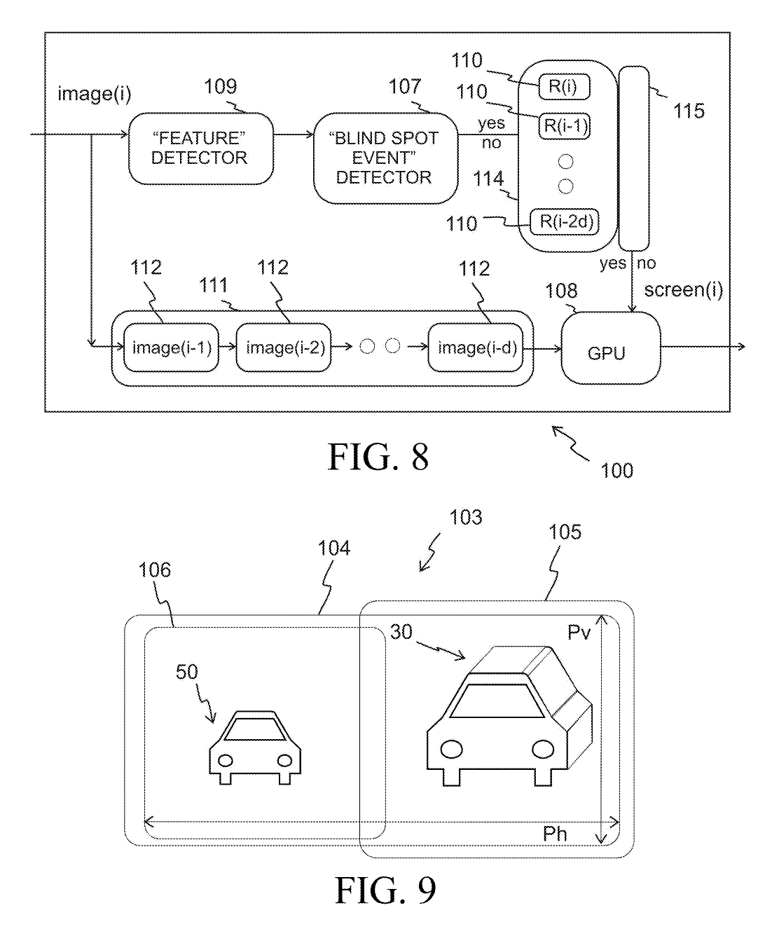

Referring to FIG. 8, image frames are entering the controller 100. The current time index is i, therefore the current image is image(i). Further, the previous d images are denoted by image(i−1) to image(i−d), where image(i−1) is the image in the previous frame and so on.

The first modification of the controller 100 is the addition of a buffer 111. The buffer 111 has d memory arrays 112. The memory arrays 112 store the content of the image module 103 for the past d images: image(i−1) to image(i−d).

The second modification of the controller 100 is the addition of a second buffer 114.

The second buffer 114 has 2d+1 memory registers 110. The memory arrays 110 store the ‘yes’ and ‘no’ outputs of the blind spot event detector 107 outputs: R(i) to R(i−2d), where R(i) is the output of the blind spot event detector 107 at the current time, index=i, and R(i−1) is the output at previous time, index=i−1, corresponding to the previous image frame, image(i−1), and so on.

The third modification is the addition of a decision box 115. The decision box 115 outputs a ‘yes’ or a ‘no’ according to the following:

The output of the decision box 115=‘yes’ if [R(i−j) R(i−j−1) R(i−j−2) R(i−j−d)]=all ‘yes’ for at least one j, 0≦j≦d.

The fourth and the final modification is that at current time, index=i, the output of the GPU 108, screen(i), is based on the image module 103 corresponding to index=i−d; there is a delay d between image(i) and screen(i).

To explain the controller 100 in FIG. 8, first assume that for a moment the decision box 115 abstains its operations as described above and it outputs R(i−d). It is not hard to see that the controller 100 of FIG. 8 produces a delayed version of the output of the controller 100 in FIG. 7, delayed by d frames. However, when the decision box 115 is engaged as described earlier, bursts of “yes's” of length d or less are turned to “no's”. Therefore, false detections of blind spot events that last for less than d+1 frames are ignored.

In the above described embodiment (the “first embodiment”), d=2 has been used successfully.

### The Second Embodiment

The second embodiment relates to the right-side mirror 22 and it is explained using FIGS. 2-8 as before and FIG. 9.

The second embodiment of an image processing based dynamically adjusting surveillance system 70 comprises the controller 100, the video camera 101, and the monitor 102 as before.

When the image processing based dynamically adjusting surveillance system 70 is used instead of the right side mirror 22, then FIG. 9 shows a view of the image module 103 of the camera 101 when the automobile 20 is in a situation similar to one depicted in FIG. 1. While the right-side mirror 22 shows only the automobile 50, it is noted that both automobiles 30 and 50 are in the view of the image module 103 in FIG. 9. In FIG. 9, the rectangle 106 shows the pixels of the image module 103 that generally correspond to a view of the right-side mirror 22. The region defined by the rectangle 106 is the second predetermined region in the second embodiment.

Also, the rectangle 105 shows the pixels of the image module 103 that generally correspond to a view of the blind spot of the right-side mirror 22. The region defined by the rectangle 105 is the first predetermined region in this embodiment.

The operation of the controller 100 based on FIG. 4 is the same as before, except when the GPU 108 receives a ‘0’, indicating no blind spot events, then its output, ‘screen’, is based on the pixels in the rectangle 106, the second predetermined region, of FIG. 9. Therefore, the view of the monitor 102 would correspond to a view of the right-side mirror 22.

For example, if the automobile 30 is not present but the automobile 50 is present, then there is no blind spot event and the output of the blind spot event detector 107 would be a ‘0’ and the output of the GPU 108, ‘screen’, would correspond to a view containing the automobile 50 based on the pixels in the rectangle 106, the second predetermined region.

But, if the GPU 108 receives a ‘1’, indicating a blind spot event, then its output, ‘screen’, is based on the pixels in the rectangle 105, the first predetermined region of the second embodiment of FIG. 9. Therefore, the view of the monitor 102 would correspond to a view of the blind spot of right-side mirror 22.

For example, if the automobile 30 is present but the automobile 50 is not present, then there is a blind spot event and the output of the blind spot event detector 107 would be a ‘1’ and the output of the GPU 108, ‘screen’ would correspond to a view containing the automobile 30 based on pixels in the rectangle 105, the first predetermined region. It is noted that if both automobiles 30 and 50 are present, then the view of the monitor 102 would be the same as in the case when only the automobile 30 is present. This bias toward the automobile 30 is again intentional since the automobile 30 threatens the safety of the automobile 20 more than the automobile 50 does in general. For example, if the driver of the automobile 20 changes into his/her right lane, then the automobile 20 would crash into the automobile 30.

Thus, the image processing based dynamically adjusting surveillance system 70, according to the second embodiment, provides a view of the blind spot of the right-side mirror 22 when there is an automobile in the blind spot.

The operation of the controller 100 based on FIGS. 5 and 6 stays the same as in the first embodiment except the following changes are needed:

The blind spot event detector 107 of FIG. 5 switches its treatment of the rectangles 105 and 106. Here, it treats 106 as it did 105 before, and it treats 105 as it did 106 before. Specifically, if any one of the received matrices has a ‘1’ in the columns defined by the rectangle 105 of FIG. 6, then the blind spot event detector 107 outputs a ‘yes’, a digital ‘1’, indicating the presence of a configured feature.

If all coordinates of the matrices corresponding to the columns in the rectangle 105 are zero, then the blind spot event detector 107 outputs a ‘no’, a digital ‘0’, indicating the absence of a configured feature.

Again, in order to preclude false detection of a few pathological situations, a more complex algorithm may be used for the blind spot event detector 107. To this end, the following finite state machine description may be used for the blind spot event detector 107.
The blind spot event detector 107 has an internal three dimensional state s=(s1, s2, s3). The state, s, is initialized in the beginning.
The blind spot event detector 107 receives the configured features matrices, M1-M5. If a feature, k, 1≦k≦5 is not configured then its corresponding matrix has all zeros.
The blind spot event detector 107 uses the steps below to compute its new state as. Again as in the first embodiment, q1=7, and q2=2. It is assumed that the current state s=(Old1 Old2 Old3).

The new s1, New1, computation is as follows:

New1=0, if all M1-M5 are zeros; and

New1=i, 1≦i≦r, if the i-th row is the lowest non-zero row among M1-M5.

The new s2, New2, computation is as follows:

New2=0, if all M1-M5 are zeros; and

New2=j, 1≦j≦c, if the j-th column is the rightmost non-zero column among M1-M5.

The new s3, New3, computation is as follows:

1) If (New2>q1) AND (New1≠Old1), then New3=0. With respect to the rectangle 106 of FIG. 6, these conditions imply a) a detected feature, and b) a motion with respect to the previous frame (New1≠Old1). With respect to the rectangle 105, these conditions imply the absence of a detected feature.

2) If (New2>q1) AND (New1=Old1), then New3=Old3. With respect to the rectangle 106, these conditions imply a) a detected feature (New2>q1), and b) and an uncertainty about motion with respect to the previous frame (New1=Old1). With respect to the rectangle 105, these conditions imply the absence of a detected feature.

3) If (New2≦q1) AND (New1<Old1), then New3=0. With respect to the rectangle 105, these conditions imply a) a detected feature (New2≦q1), and b) and an upward motion with respect to the previous frame (New1<Old1).

4) If (New2≦q1) AND (New1=Old1), then New3=Old3. With respect to the rectangle 105, these conditions imply a) a detected feature (New2<q1), and b) and an uncertainty about motion with respect to the previous frame (New1=Old1).

5) If (New2≦q1) AND (New1>Old1) AND (Old1>0) AND (|New2−Old2|)≦q2, then New3=1. With respect to the rectangle 105, these conditions imply a) a detected feature (New2>q1), b) and a downward motion with respect to the previous frame (New1>Old1), c) the presence of the detected feature in the previous frame (Old1>0) and d) leftward motion of no more than 2 squares from the previous frame.

6) If (New2≦q1) AND (New1>Old1) AND (Old1>0) AND (|New2−Old2|>q2), then New3=0. With respect to the rectangle 105, these conditions imply a) a detected feature (New2>q1), b) and a downward motion with respect to the previous frame (New1>Old1), c) the presence of the detected feature in the previous frame (Old1>0) and d) leftward motion of more than 2 squares from the previous frame. In the second embodiment as in the first embodiment, in condition 6), motion of 3 or more squares from a frame to the next frame indicates a high likelihood of more than one object of interest facing in the opposite direction.

7) If (New2≦q1) AND (New1>Old1) AND (Old1=0) New3=0. With respect to the rectangle 105, these conditions imply a) a detected feature (New2>q1), b) and a downward motion with respect to the previous frame (New1>Old1), c) the absence of the detected feature in the previous frame (Old1=0). Therefore, these conditions imply a leftward motion of more than 3 squares, New2−Old2=New2−0>q1=7.

As in the first embodiment, in condition 7), motion of 3 or more squares from a frame to the next frame indicates a high likelihood of more than one object of interest facing in the opposite direction.
The blind spot event detector 107 outputs New3 (‘0’ or ‘1’) and updates its state to s=(New1 New2 New3).

In the current design of the controller 100, while the output of the blind spot event detector 107 is a ‘no’, the GPU 108 displays a view in the image module 103 that is in the rectangle 106. Once an object is detected in the blind spot area, or equivalently if the blind spot event detector 107 outputs a ‘yes’, then the GPU 108 displays the view in the image module 103 that is inside the rectangle 105.

The operation of the image processing based dynamically adjusting surveillance system 70 according the second embodiment might generally be unaffected if only gi,j's were used where j<10. This restriction would simply the design of the image processing based dynamically adjusting surveillance system 70.

The controller 100 of the second embodiment might be modified to ignore short runs of ‘yes's as in the first embodiment. The solution described based on FIG. 8 applies directly, the blind spot detector 107 and the GPU 108 of the first embodiment is replaced with their corresponding counterparts for the second embodiment explained above.

### The Third Embodiment

In the first and second embodiments the view of the monitor 102 is one of two predetermined regions of the image module 103. The first predetermined region includes the blind spot, and the second predetermined region is generally a view of a traditional side mirror. The monitor 102 displays the first predetermined region when there is detected object of interest in the blind spot area, and the monitor displays the second first predetermined region when there are no detected objects of interest in the blind spot area.

The third embodiment further demonstrates advantages of the present invention.

In the third embodiment, again in the absence of a blind spot event, the key region is defined by a second predetermined region, capturing a view of a conventional side mirror. But, in the presence of a blind spot event the key region is a portion of the camera image that not only contains the second predetermined region but also at least one detected feature of at least one object of interest. Thus, in this embodiment, the key region always contains the second predetermined region.

More specifically, the third embodiment relates to the left-side mirror 21, and the key region, in the presence of a detected object of interest, is a portion of the camera image that not only contains the second predetermined region but also the leftmost detected feature of an object of interest.

The third embodiment is explained using FIGS. 2, 10 and 11.

The third embodiment comprises the camera 101, the monitor 102, and the controller 100 of FIG. 2.

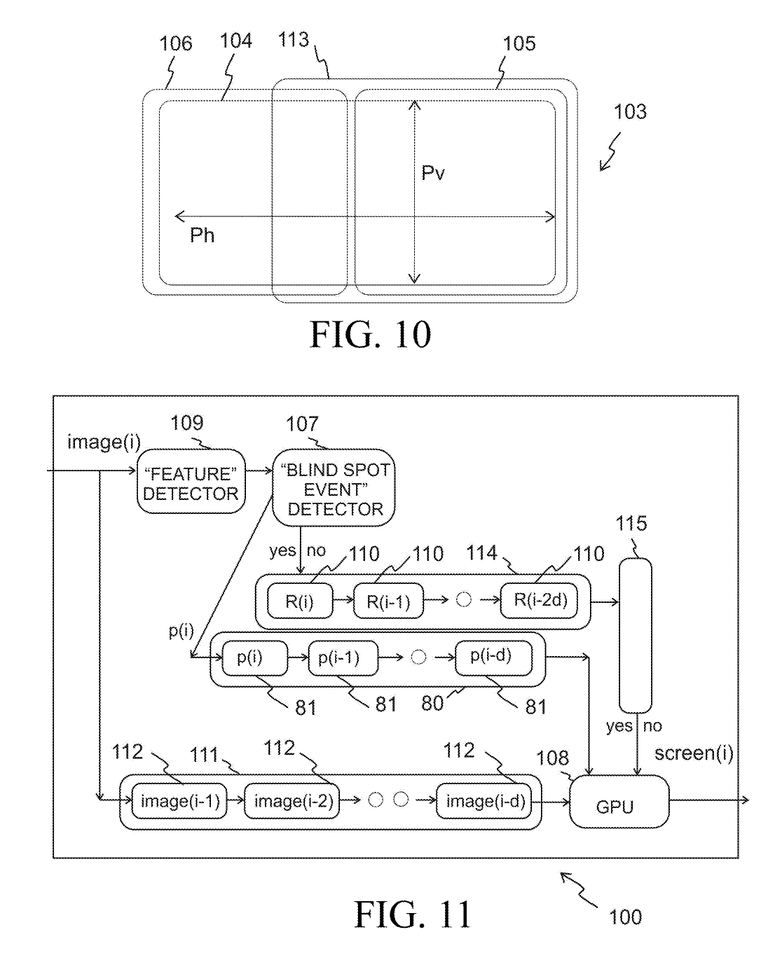

Referring to FIG. 10, both the first and the third embodiments use the same rectangle 105 to define the second predetermined region, but while the first embodiment uses the rectangle 106 for its first predetermined region, the third embodiment uses a rectangle 113. The rectangle 113 includes the rectangle 105, and it stretches leftward into the parts of the rectangle 106. The width of the rectangle 113 is not fixed. It stretches enough to include all detected features that are in the rectangle 106.

The controller 100 further can be described using FIG. 11. The controller 100 in FIG. 11 differs from the controller 100 of the first embodiment of FIG. 8 in the following aspects:

1) Recall the internal state, s, of the finite state machine description of the blind spot event detector 107 of the first embodiment has three dimensions (s1, s2, s3)=(New1, New2, New3). Also recall that the blind spot event detector 107 of FIG. 8 outputs New3. However, the blind spot event detector 107 of FIG. 11 outputs both New2 and New3.

If New2=0, then no configured feature has been detected, but if New2>0, then New2 indicates the location of a leftmost column in M's that is not zeros. In other words, an object of interest has been detected and the leftmost detected part of the object is in column=New2.

The second output, New2, of the blind spot event detector 107 at time index=i is denoted by p(i), as shown in FIG. 11.

2) The controller 100 of FIG. 11 has a buffer 80. The buffer 80 has d+1 memory registers 81. The memory registers 81 store p(i) to p(i−d). The decision box 115 is the same as before.

3) The GPU 108 has two inputs: one from the decision box 115, and one from the buffer 80, p(i−d). Now the GPU 108 produces its output, screen(i), of the time index=i as follows:

When the input from the decision box 115 is a ‘no’, the GPU 108 displays a view in the image module 103 that is in the rectangle 105, the second predetermined region. In other words, while no configured feature is present for more than d frames in the blind spot of the left-side mirror 21, then the monitor 102 displays a view corresponding to a view of a conventional left-side mirror.

But when the input of the decision box 115 is a ‘yes’, the GPU 108 displays a view in the image module 103 that is in a rectangle 113 in FIG. 10. The rectangle 113 has a variable width. Referring to FIG. 6, the rectangle 113 contains the pixels of the image module 103 in grid squares, gm,n's such that 1≦m≦r and 1≦n≦q(i−d). By construction, the rectangle 113 always includes the rectangle 105.

In other words, once objects of interest are detected for more than d frames in the blind spot of the left-side mirror 21, then the monitor 102 displays a view corresponding to a view of the image module 103 that is inside the rectangle 113, which not only includes the rectangle 105 by construction but also the leftmost detected portion of the object of interest in the blind spot.

### The Fourth Embodiment

The fourth embodiment improves on the right-side mirror 22 the same way the third embodiment improved on the left-side mirror 21. Specifically, the key region in the presence of a detected object of interest is a portion of the camera image that not only contained the second predetermined region but also the rightmost detected feature of an object of interest.

The fourth embodiment is explained using FIGS. 2, 11 and 12.

The fourth embodiment comprises the camera 101, the monitor 102, and the controller 100 of FIG. 2.

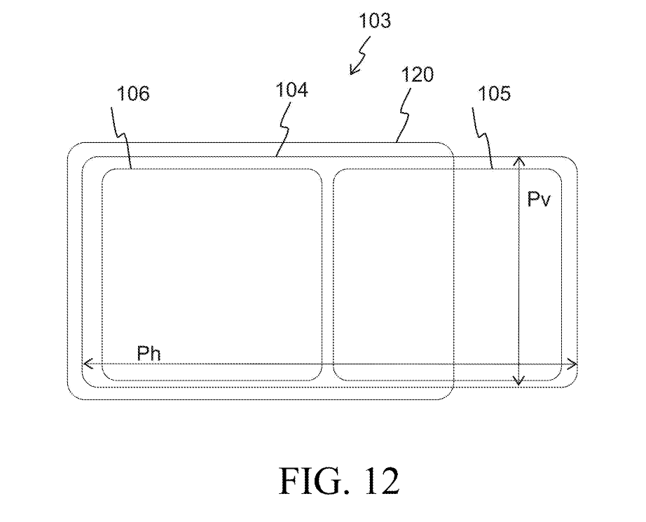

Referring to FIG. 12, both the second and the fourth embodiments use the same rectangle 106 to define the second predetermined region, but while the second embodiment uses the rectangle 105 for its first predetermined region, the fourth embodiment uses a rectangle 120. The rectangle 120 includes the rectangle 106, and it stretches rightward into the parts of the rectangle 105. The width of the rectangle 120 is not fixed. It stretches enough to include all detected features that are in the rectangle 105. It is noted that the rectangle 106, the second predetermined region, captures a view of a conventional right-side mirror.

The controller 100 further can be described using FIG. 11. The controller 100 in FIG. 11 of the fourth embodiment differs from the controller 100 of the second embodiment of FIG. 8 in the following aspects:

1) Recall the internal state, s, of the finite state machine description of the blind spot event detector 107 of the second embodiment has three dimensions (s1, s2, s3)=(New1, New2, New3). Also recall that the blind spot event detector 107 of FIG. 8 outputs New3. However, the blind spot event detector 107 of FIG. 11 outputs both New2 and New3.

If New2=0, then no configured feature has been detected, but if New2>0, then New2 indicates the location of a rightmost column in M's that is not zeros. In other words, an object of interest has been detected and the rightmost detected part of the object is in column=New2.

The second output, New2, of the blind spot event detector 107 at time index=i is denoted by p(i), as shown in FIG. 11.

2) The controller 100 of FIG. 11 has a buffer 80. The buffer 80 has d+1 memory registers 81. The memory registers 81 store p(i) to p(i−d). The decision box 115 is the same as before.

3) The GPU 108 has two inputs: one from the decision box 115, and one from the buffer 80, p(i−d). Now the GPU 108 produces its output, screen(i), of the time index=i as follows:

When the input from the decision box 115 is a ‘no’, the GPU 108 displays a view in the image module 103 that is in the rectangle 106, the second predetermined region. In other words, while no configured feature is present for more than d frames in the blind spot of the right-side mirror 22, then the monitor 102 displays a view corresponding to a view of a conventional right-side mirror.

But, when the input of the decision box 115 is a ‘yes’, the GPU 108 displays a view in the image module 103 that is in a rectangle 120 in FIG. 12. The rectangle 120 has a variable width. Referring to FIG. 6, the rectangle 120 contains the pixels of the image module 103 in grid squares, gm,n's such that 1≦m≦r and c≦n≦q(i). By construction, the rectangle 120 always includes the rectangle 106.

In other words, once objects of interest are detected for more than d frames in the blind spot of the right-side mirror 22, then the monitor 102 displays a view corresponding to a view of the image module 103 that is inside the rectangle 120, which not only includes the rectangle 106 by construction but also the rightmost detected portion of the object of interest in the blind spot.

In all of the above described embodiments, a warning device might be connected to the controller such that when the GPU 108 has a ‘yes’ input, the warning device would turn on, warning a driver about an automobile in the blind spot. The warning device could either make a sound or display a warning sign on the monitor.

For each side mirror, more than one camera can be used such that they provide a very wide angle of view, such as a panorama view. This would enlarge the image module 103.

In the third and fourth embodiments, instead of the variable width rectangle 113, 120, a fixed width rectangle might be used by not stretching the rectangle 113, 120 to reach the right edge (third embodiment) or left edge (fourth embodiment) of the image module 113. In this case, the rectangle 113, 120 would no longer include the rectangle 105, 106.

The overall brightness of the images from the camera 101 may be brightened before passing them to the controller 100. Alternatively, one might make adjustments to the offsets to avoid false alarms and missing detections in very bright or very dark situations.

A GPS signal might be provided to the controller 100. Thereby at intersections, the GPU 108 might display a predetermined third region of the image module 103 that would provide a driver of the automobile 20 a view of a portion of the cross traffic.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An image processing based dynamically adjusting surveillance system comprising:
at least one camera configured to capture a view containing a key region that encompasses a desired view;
a control unit receiving a camera image from the camera, the control unit using image processing based detection configured to detect desired objects in a region of the image of the camera; and
a monitor that displays images it receives from the control unit.

2. The image processing based dynamically adjusting surveillance system according to claim 1, wherein the control unit further displays the key region on the monitor.

3. The image processing based dynamically adjusting surveillance system according to claim 2, wherein the camera image has a first predetermined region.

4. The image processing based dynamically adjusting surveillance system according to claim 3, wherein the key region is the first predetermined region when the controller detects a desired object inside the first predetermined region.

5. The image processing based dynamically adjusting surveillance system according to claim 3, wherein the camera image has a second predetermined region.

6. The image processing based dynamically adjusting surveillance system according to claim 5, wherein the key region is the second predetermined region in the camera image when the controller does not detect any desired object inside the first predetermined region.

7. The image processing based dynamically adjusting surveillance system according to claim 1, wherein detection of the desired objects is performed based on detection of at least one pictorial feature of the desired object.

8. The image processing based dynamically adjusting surveillance system according to claim 7, wherein the pictorial feature provides positive indication of the presence of the desired object.

9. The image processing based dynamically adjusting surveillance system according to claim 7, wherein the pictorial feature is selected from at least one of a tire, a body part, a front light, a brake light and a night light.

10. The image processing based dynamically adjusting surveillance system according to claim 3, wherein the key region is a portion of the camera image containing at least one detected feature of at least one desired object.

11. An image processing based dynamically adjusting surveillance system comprising:
at least one camera configured to capture a view containing a key region that encompasses a desired view, wherein the view includes a first predetermined region and a second predetermined region;
a control unit receiving the view from the camera, the control unit using image processing based detection configured to detect desired objects in a region of the view of the camera; and
a monitor that displays images it receives from the control unit, wherein
the key region is the first predetermined region when the controller detects a desired object inside the first predetermined region; and
the key region is the second predetermined region when the controller does not detect any desired object inside the first predetermined region.

12. The image processing based dynamically adjusting surveillance system according to claim 11, wherein detection of the desired objects is performed based on detection of at least one pictorial feature of the desired object.

13. The image processing based dynamically adjusting surveillance system according to claim 12, wherein the pictorial feature provides positive indication of the presence of the desired object.

14. The image processing based dynamically adjusting surveillance system according to claim 12, wherein the pictorial feature is selected from at least one of a tire, a body part, a front light, a brake light and a night light.

15. A method for detecting when a vehicle lane change may be safely completed, the method comprising:
capturing a view containing a key region that encompasses a desired view with at least one camera;
receiving a camera image from the camera to a control unit;
detecting a desired object in a region of the camera image with image processing based detection; and
display at least a portion of the camera image on a monitor.

16. The method according to claim 15, wherein the camera image has a first predetermined region and a second predetermined region.

17. The method according to claim 16, further comprising assigning the key region to the first predetermined region when the controller detects a desired object inside the first predetermined region.

18. The method according to claim 16, further comprising assigning the key region to the second predetermined region when the controller does not detect any desired object inside the first predetermined region.

19. The method according to claim 15, detecting at least one pictorial feature of the desired object.

20. The method according to claim 16, further comprising adjusting a size of the first predetermined region and the second predetermined region to capture an appropriate view as the key region displayed on the monitor.
